(19) United States
(12) Patent Application Publication
(10) Pub. No.: US 2009/0320143 A1
(43) Pub. Date: Dec. 24, 2009

(54) SENSOR INTERFACE

(75) Inventors: Gavin Gear, Bothell, WA (US); Gregory Parks, Redmond, WA (US); Daniel Polivy, Seattle, WA (US); Trevor Armstrong, Bellevue, WA (US); Frank Chen, Renton, WA (US); Prasanna Kumar Padmanabhan, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/144,631

(22) Filed: Jun. 24, 2008

(51) Int. Cl. G06F 21/22; G06F 9/54

(52) U.S. Cl. 726/29; 719/328

(57) ABSTRACT

A sensor application programming interface (API) is capable of restricting an application's access to sensor data measured by a sensor, while at the same time providing access to sensor properties of the sensor, even if access has not been granted to the application for the sensor.

### BACKGROUND

Computing devices may be connected to sensor devices that can measure various aspects of the physical world. Such sensors are typically specifically configured for use with a particular computing device or type of computing device. Furthermore, applications of the computing device are typically specifically configured to receive measurements from each different sensor. It can become difficult for application developers and sensor manufactures to maintain compatibility between all applications and all sensors.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A sensor application programming interface (API) is disclosed. The Sensor API is capable of restricting an application's access to sensor data measured by a sensor, while at the same time providing access to sensor properties of the sensor, even if access has not been granted to the application for the sensor.

### BRIEF DESCRIPTION OF THE DRAWINGS

FIG. 1 somewhat schematically shows an example embodiment of a Sensor API that provides sensor access to an application or operating system module.

FIG. 2 is an example embodiment of a class diagram for a Sensor API.

FIG. 3 schematically shows an example sensor, including Sensor Properties and Sensor Data Fields, as well as an example data report corresponding to the sensor.

FIG. 4 schematically shows a process flow of an example method of enabling an application to find a sensor while limiting unauthorized access to sensor data measured by the sensor.

### DETAILED DESCRIPTION

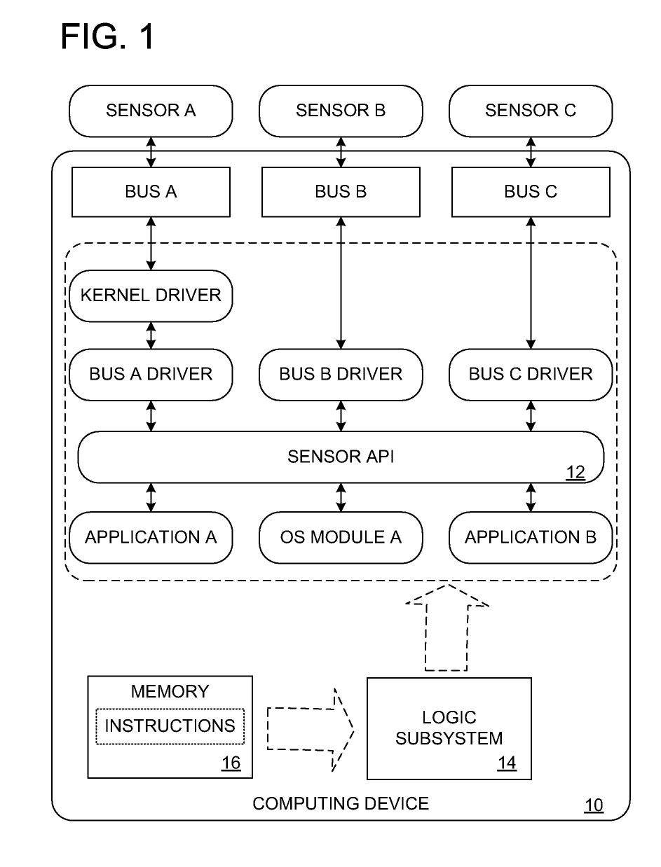

FIG. 1 shows an example of a computing device 10 configured to utilize a Sensor API 12 (i.e., sensor application programming interface) for accessing and interacting with one or more sensors (e.g., Sensor A, Sensor B, and Sensor C). Such a Sensor API allows various applications (e.g., Application A and Application B) and/or operating system modules (e.g., Operating System Module A) to obtain relevant sensor measurement data and/or sensor properties in a consistent manner, thus alleviating each individual application or operating system module from the burden of individually defining its own procedures for accessing and interacting with each different sensor.

Computing device 10 includes a logic subsystem 14 and computer-readable memory 16. The computing device also include a plurality of different busses (e.g., Bus A, Bus B, and Bus C) configured to operatively connect sensors (e.g., Sensor A, Sensor B, and Sensor C) to the computing device. The herein disclosed Sensor API may be adapted for use with virtually any computing device running virtually any operating system. The disclosed computing device is provided as an example for explanatory purposes.

Logic subsystem 14 may be configured to execute one or more instructions. For example, the logic subsystem may be configured to execute one or more instructions that are part of one or more programs, routines, objects, components, data structures, application programming interfaces, or other logical constructs. Such instructions may be implemented to perform a task, implement an abstract data type, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Computer-readable memory 16 may include a device configured to hold instructions that, when executed by the logic subsystem, cause the logic subsystem to implement the herein described methods, processes, and/or application programming interfaces. As an example, the memory may hold instructions that, when executed by logic subsystem 14, enable an application programming interface to interact with one or more sensors. Memory 16 may include volatile portions and/or nonvolatile portions. In some embodiments, memory 16 may include two or more different devices that may cooperate with one another to hold instructions for execution by the logic subsystem. In some embodiments, logic subsystem 14 and memory 16 may be integrated into one or more common devices and/or computing systems.

FIG. 1 somewhat schematically illustrates Sensors A, B, and C, which may be of the same or different type, make, model, and/or which may interface with computing device 10 using the same or different interface. Virtually any type of sensor may be used with the herein described Sensor API, including, but not limited to, ambient light sensors, accelerometers, pressure sensors, altitude sensors, GPS sensors, IP resolvers, motion detectors, gyrometers, temperature sensors, humidity sensors, wind speed sensors, wind direction sensors, and the like.

For illustrative purposes, each of Sensors A, B, and C are operatively connected to computing device 10 using a different bus of the computing device. It should be understood that a particular sensor may be configured to interface with a computing device using one or more different busses, and some sensors may interface with a computing device using different busses than other sensors. The herein described Sensor API is configured to be bus and sensor agnostic, providing all applications (e.g., Application A and Application B) and/or operating system modules (e.g., Operating System Module A) a common mechanism with which to interface with virtually any sensor which is connected to computing device 10 using virtually any connection technology. In other words, applications or operating system modules may access any sensor via the Sensor API in the same way, without needing knowledge of the specifics of the hardware, loaded driver, or bus which the particular sensor uses.

Each sensor may expose one or more sensor data fields that have a corresponding sensor data type. The Sensor API may implement a sensor data compatibility-convention specifying that each sensor offers sensor data including a value of a quantifiable phenomenon. The sensor data compatibility-convention can further specify a union of a phenomenon being measured and the units in which the phenomenon is measured. That is, in some embodiments, the Sensor API specifies that each sensor offers sensor data including a unit of measurement corresponding to the value of the quantifiable phenomenon. Phenomenon may include quantifiable occurrences in the physical world, such as pressure, force, voltage, and acceleration. Because the units of measurement may be included in the definition of a sensor data type, as specified by the sensor data compatibility convention, ambiguity between data types with different units of measurement can be avoided (e.g., temperature measured using degrees Fahrenheit as opposed to temperature measured using degrees Celsius). Sensor data types can also include the point of reference (i.e., datum) relative to the measurements, other points of reference, and/or other information.

Each sensor may be characterized as having a particular type. The Sensor API may implement a sensor-type property, the sensor-type property specifying, for each sensor, a method of measurement that sensor uses to offer its sensor data. For example, all global positioning system (GPS) sensors may have the same sensor-type properties as one another, while all IP resolver sensors may have a different sensor-type property than the GPS sensors. Sensors of the same type use the same method of measurement and may expose the same sensor data fields. Sensors of different types use different methods of measurement. The sensor-type property can be exposed, for each sensor assigned a sensor-type property, by a driver for that sensor. In some embodiments, the sensor-type may be built-in to the sensor itself, or another mechanism in the computing device may be configured to expose the sensor-type property.

In addition to sensor types, each sensor may belong to one or more sensor categories. Sensor categories are groupings of related sensors (e.g., environmental sensors, motion sensors, visual sensor, auditory sensors, biometric sensors, etc.). A category may include a variety of different sensor types. As a nonlimiting example, environmental sensors may include temperature sensors, atmospheric pressure sensors, humidity sensors, wind speed sensors, wind direction sensors, and the like. As another nonlimiting example, motion sensors may include accelerometers calibrated for measurement along different axis, motion detectors, GPS sensors, gyrometers, and the like. Sensors belonging to the same category may expose the same or similar data fields, however the accuracy and/or resolution of the data may vary between different types of sensors belonging to the same category.

The Sensor API may implement a sensor-category property, different than the sensor-type property. The sensor-category property may specify, for one or more sensors, a higher-level taxonomy grouping related sensor types. The sensor-category property can be exposed, for each sensor assigned a sensor-category property, by a driver for that sensor. In some embodiments, the sensor-category may be built-in to the sensor itself, or another mechanism in the computing device may be configured to expose the sensor-category property. The use of a multi-level taxonomy allows an application or operating system module to discover related sensors, which may have different types, without having to individually query each particular type.

Sensors sometimes may have the same sensor-category property as other sensors having different sensor-type categories, but which expose overlapping data fields. For example, because a GPS sensor and an IP resolver sensor may both provide latitude sensor data and longitude sensor data, the GPS sensor and the IP resolver sensor may be assigned to the same category. Sensors offering sensor data for different but related quantifiable phenomenon may be assigned different sensor-type properties but the same sensor-category properties. For example, although an accelerometer provides acceleration sensor data and a GPS provides positional data, the accelerometer and the GPS may belong to the same category (e.g., motion) but different types (e.g., accelerometer and GPS, respectively). As such, the sensor-category property of the application programming interface allows sensors with different sensor types to belong to the same sensor category.

Using sensor categories is helpful when related sensors are of interest. For example, it may be desirable for an application or operating system module to obtain all sensors of a particular category, then to examine sensor properties and in turn filter by some criteria of interest. To facilitate such functionality, the Sensor API may implement a get-sensors-by-category call configured to return all available sensors belonging to a specified category. Such an approach may provide advantages over obtaining sensors by type and/or any other mechanism.

However, in some embodiments, it may be desirable to obtain all sensors having a particular type or a sensor by its unique identifier. To facilitate such functionality, the Sensor API may implement a get-sensors-by-type call configured to return all available sensors having a specified type and/or a get-sensors-by-ID call configured to return a sensor having a specified unique identifier.

The above described calls may be used by an application and/or operating system module to determine which sensors are available. Depending on the sensors that are available, the application and/or operating system module may provide different levels of functionality.

The Sensor API may implement a get-data call configured to return measured sensor data for a specified sensor (e.g., values of the phenomenon that sensor measures). In some embodiments, a get-data call may be used to retrieve a particular sensor data field and/or all sensor data fields offered by the sensor. The data fields can be inferred by the category/type and/or queried from the device.

Sensors can measure data that a user may wish to keep secret (e.g., personally identifiable information) from one or more applications and/or operating system modules (e.g., the user's current location). Accordingly, the application programming interface can be configured to return an access-denied message to a get-data call for a specified sensor if access has not been granted to a particular application or operating system module for the specified sensor. In order to access sensor data, a sensor is first enabled by a user (or pre-enabled by an original equipment manufacturer of the computing device) for a particular application or operating system module. To facilitate the granting of such permissions, the Sensor API may implement a request-permissions call for prompting a user to grant access to a specified sensor. If an application or operating system module wishes to obtain access to a sensor which is not enabled, the application or operating system module can use the request-permissions call to prompt the user to assign permissions for the sensor. Permissions may be granted on a per-device/per-user or per-application basis, for example. In some embodiments, permissions may be granted for only a certain period of time and/or while one or more other preselected conditions or criteria are satisfied. It will be understood that permissions may be requested and/or granted using a variety of different procedures, and the above is provided as a nonlimiting example.

Even if access has not been granted for a specified sensor, there are situations in which it may be desirable for an application or operating system module to be able to find the sensor and/or retrieve non private information from the sensor. As such, the Sensor API may implement a get-sensor-property call configured to return a property describing a specified aspect of a specified sensor. Such aspects may include sensor category, sensor type, sensor manufacturer, sensor model, sensor serial number, sensor data field(s), accuracy of sensor data, resolution of sensor data, and the like. The Sensor API can be configured to return a requested property even if access has not been granted for a specified sensor. As such, even before access is granted for a sensor, an application or operating system module may obtain property information from the sensor. This allows a user to maintain a desired level of privacy, while at the same time providing applications and operating system modules enough information to determine if the user should be asked to permit full access for a particular sensor.

If there are one or more access-restricted sensors that could be used by an application and/or operating system module, the application and/or operating system module may use the Sensor API to prompt the user to assign permissions. In this way, the user can choose whether to grant access to the application or operating system module. This level of restriction allows the application to determine which sensors are of interest prior to prompting the user for permissions, and to only enable sensors that can be used by the application.

In some implementations, prior to prompting the user for permissions, the application may use an event-sink call that enables the application and/or operating system module to monitor when permissions have been granted to that sensor, for example, by alerting the application or operating system module to check if the sensor state has been changed. The Sensor API may implement a sensor-event call that enables a sensor to report a state or occurrence of interest for that sensor. As nonlimiting examples, the sensor-event call can enable a sensor to report access has been granted for the sensor and/or that a state of the sensor has changed.

In some embodiments, sensors with permissions may be fully functional, and sensors without permissions may be fully functional except that a get-data call returns an access-denied message, a set-properties call returns an access-denied message, and a set-even-sink call succeeds but the corresponding sensor-event will not be fired.

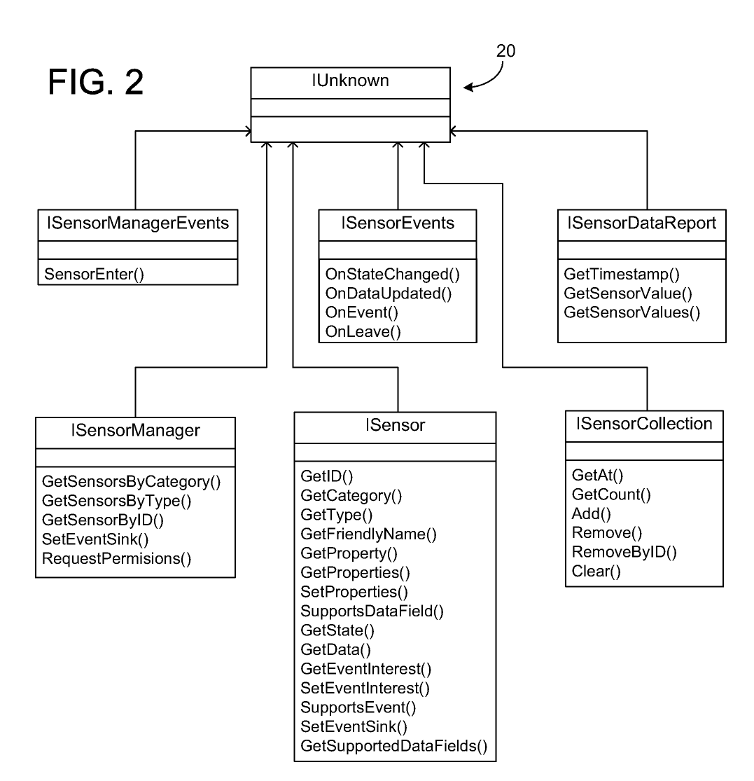

FIG. 2 shows a nonlimiting example of a class diagram 20 for a Sensor API. A Sensor API can be formulated in virtually any number of different ways while remaining within the scope of the present disclosure, and class diagram 20 of FIG. 2 is provided for exemplary purposes. Class diagram 20 includes references to each of the calls (i.e., methods) and events described above, including the get-data call (e.g., GetData( )), the get-sensor-property call (e.g., GetProperty( ) and GetProperties( )), the request-permissions call (e.g., RequestPermissions( )), the get-sensors-by-category call (e.g., GetSensorsByCategory( )), the get-sensors-by-type call (e.g., GetSensorsByType( )), and the get-sensors-by-ID call (e.g., GetSensorByID( )). As may be appreciated, the illustrated class diagram includes many calls not explicitly described above. Those skilled in the art will appreciate the functionality of such calls based on the descriptive names given to the calls. Furthermore, those skilled in the art will appreciate that a Sensor API may be modified to provide additional and/or alternative functionality.

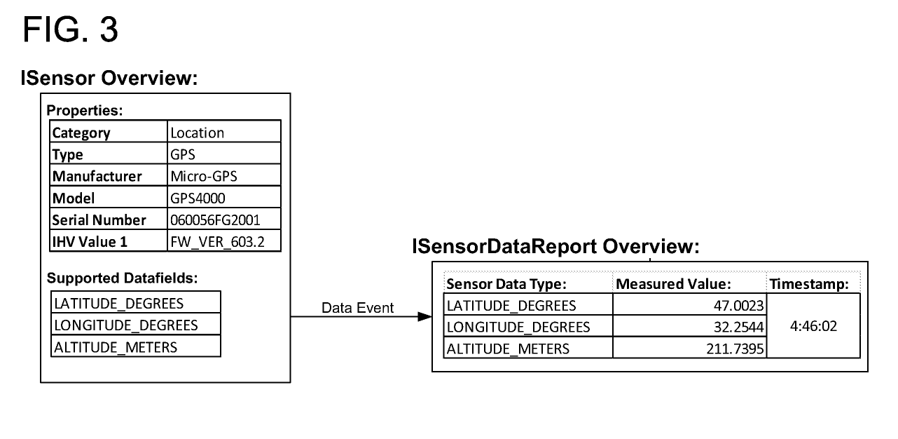

FIG. 3 schematically shows an example sensor, including Sensor Properties and Sensor Data Fields, as well as an example data report corresponding to the sensor.

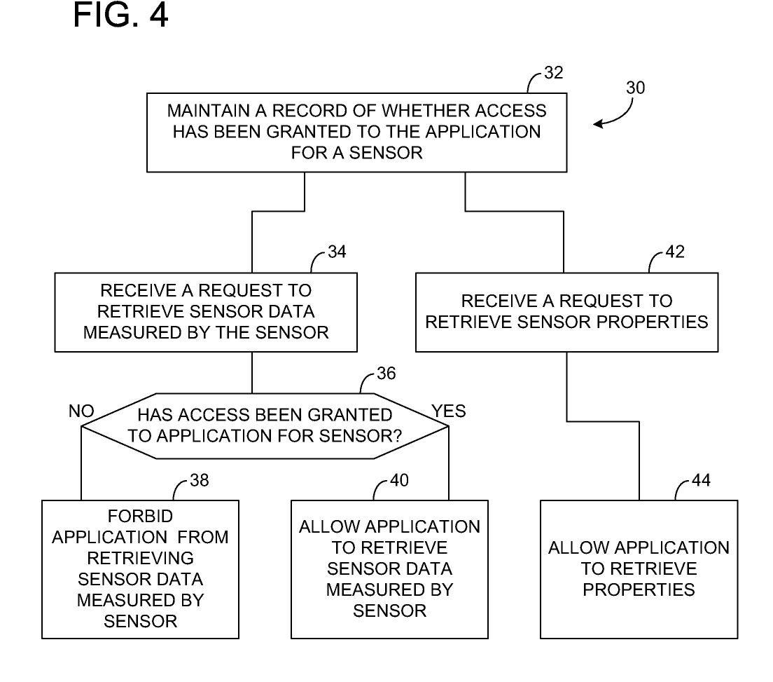

FIG. 4 shows a process flow of a method 30 of enabling an application to find one or more sensors while limiting unauthorized access to sensor data measured by the one or more sensors. At 32, method 30 includes maintaining a record of whether access has been granted to the application (or operating system module) for a sensor. At 34, method 30 includes receiving a request to retrieve sensor data measured by the sensor. At 36, it is determined if access has been granted to the application for the sensor. If access has not been granted, at 38, the method includes forbidding the application from retrieving the sensor data from the sensor. If access has been granted, at 40, the method includes allowing the application to retrieve sensor data measured by the sensor. At 42, the method includes receiving a request to retrieve sensor properties. At 44, the method includes allowing the application to retrieve properties describing a specified aspect of the sensor. The properties may be provided even if access to the sensor data has not been granted to the application for the sensor.

It will be appreciated that the embodiments described herein may be implemented, for example, via computer-executable instructions or code, such as programs, stored on computer-readable storage media and executed by a computing device. Generally, programs include routines, objects, components, data structures, and the like that perform particular tasks or implement particular abstract data types. As used herein, the term “program” may connote a single program or multiple programs acting in concert, and may be used to denote applications, services, or any other type or class of program. Likewise, the terms “computer,” “computing device,” “computing system,” and the like include any device that electronically executes one or more programs, including two or more such devices acting in concert.

It should be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of enabling an application to find one or more sensors while limiting unauthorized access to sensor data measured by the one or more sensors:
maintaining a record of whether access has been granted to the application for a sensor;
if access has been granted to the application for the sensor, allowing the application to retrieve sensor data measured by the sensor;
if access has not been granted to the application for the sensor, forbidding the application from retrieving the sensor data from the sensor; and
even if access has not been granted to the application for the sensor, allowing the application to retrieve from the sensor one or more properties describing a specified aspect of the sensor.

2. The method of claim 1, further comprising prompting a user to grant the application access to the sensor if access has not been granted to the application for the sensor.

3. Computer-readable memory including instructions, that when executed by a processing subsystem, enable an application programming interface to interact with one or more sensors, the application programming interface implementing:
a sensor data compatibility-convention specifying that each of the one or more sensors offer sensor data including a value of a quantifiable phenomenon;
a get-data call configured to return sensor data for a specified sensor, the application programming interface configured to return an access-denied message to a get-data call for a specified sensor if access has not been granted for the specified sensor; and
a get-sensor-property call configured to return a property describing a specified aspect of a specified sensor, the application programming interface configured to return the property even if access has not been granted for the specified sensor.

4. The computer-readable memory of claim 3, where the application programming interface further implements a request-permissions call for prompting a user to grant access to a specified sensor.

5. Computer-readable memory including instructions, that when executed by a processing subsystem, enable an application programming interface to interact with one or more sensors, the application programming interface implementing:
a sensor data compatibility-convention specifying that each of the one or more sensors offer sensor data including a value of a quantifiable phenomenon;
a sensor-type property, the sensor-type property specifying, for each sensor, a method of measurement that sensor uses to offer its sensor data; and
a sensor-category property, different than the sensor-type property, specifying, for one or more sensors, a higher-level taxonomy grouping related sensor types.

6. The computer-readable memory of claim 5, where the sensor-type property and the sensor-category property are exposed, for each sensor assigned a sensor-type property or a sensor-category property, by a driver for that sensor.

7. The computer-readable memory of claim 5, where the application programming interface further implements a get-sensors-by-category call configured to return all available sensors belonging to a specified category.

8. The computer-readable memory of claim 5, where the sensor data compatibility-convention of the application programming interface further specifies that each of the one or more sensors offer sensor data including a unit of measurement corresponding to the value of the quantifiable phenomenon.

9. The computer-readable memory of claim 5, where the sensor data compatibility-convention of the application programming interface further specifies that each of the one or more sensors offer sensor data including a point of reference relative to a measurements.

10. The computer-readable memory of claim 5, where the sensor-category property of the application programming interface groups different sensor types.

11. The computer-readable memory of claim 5, where the application programming interface further implements a get-sensors-by-type call configured to return all available sensors having a specified type.

12. The computer-readable memory of claim 5, where the application programming interface further implements a get-data call configured to return sensor data for a specified sensor.

13. The computer-readable memory of claim 5, where the application programming interface further implements a get-sensors-by-id call configured to return all available sensors having a specified ID.

14. The computer-readable memory of claim 5, where the application programming interface further implements a get-sensor-property call configured to return a property describing a specified aspect of a specified sensor.

15. The computer-readable memory of claim 14, where the get-sensor-property call is configured to return an accuracy of sensor data for a quantifiable phenomenon.

16. The computer-readable memory of claim 14, where the get-sensor-property call is configured to return a resolution of sensor data for a quantifiable phenomenon.

17. The computer-readable memory of claim 5, where the application programming interface returns an access-denied message to a get-data call for a specified sensor if access has not been granted for the specified sensor.

18. The computer-readable memory of claim 5, where the application programming interface returns, responsive to a get-sensor-property call, a property describing a specified aspect of a specified sensor even if access has not been granted for the specified sensor.

19. The computer-readable memory of claim 5, where the application programming interface further implements a sensor-eventcall enabling a sensor to report a state or occurrence of interest for that sensor.

20. The computer-readable memory of claim 5, where the sensor-eventcall enables a sensor to report access has been granted for the sensor.
